(19) United States
(12) Patent Application Publication
(10) Pub. No.: US 2020/0244116 A9
(43) Pub. Date: Jul. 30, 2020

(54) MOTOR ROTOR AND MOTOR

(71) Applicant: Danfoss (Tianjin) Ltd., Tianjin (CN)

(72) Inventors: Wanzhen Liu, Tianjin (CN); Li Yao, Tianjin (CN); Yan Lin, Tianjin (CN); Guangqiang Liu, Tianjin (CN); Zhenyu Wang, Tianjin (CN); Weiping Tang, Tianjin (CN); Meng Wang, Tianjin (CN)

(21) Appl. No.: 16/233,681

(22) Filed: Dec. 27, 2018

(30) Foreign Application Priority Data
Dec. 28, 2017 (CN) 201711467201.2

(51) Int. Cl. H02K 1/27

(52) U.S. Cl. CPC H02K 1/276; H02K 1/17

(57) ABSTRACT

Embodiments of the present disclosure provide a motor rotor and a motor. The motor rotor includes: multiple groups of laminations having inner bores and arranged alternately in an axial direction of the motor rotor. The motor includes a stator and the abovementioned motor rotor provided in the stator. The motor rotor and the motor according to embodiments of the present disclosure, for example, may reduce installation costs of the laminations and a rotor shaft in the motor rotor.

### CROSS-REFERENCE TO RELATED APPLICATIONS

Applicant hereby claims foreign priority benefits under U.S.C. § 119 from Chinese Patent Application No. 201711467201.2 filed on Dec. 28, 2017, the content of which is incorporated by reference herein.

### TECHNICAL FIELD

Embodiments of the present disclosure relate to a motor rotor and a motor.

### BACKGROUND

A polygonal inner bore of a lamination in a motor rotor allows a rotor shaft to be cold pressed into the polygonal inner bore of the lamination.

### SUMMARY

Embodiments of the present disclosure provide a motor rotor and a motor, which, for example, may reduce installation costs of laminations and rotor shaft for the motor rotor.

According to an embodiment of the present disclosure, a motor rotor includes multiple groups of laminations, the multiple groups of laminations having inner bores and arranged alternatively in an axial direction of the motor rotor.

According to an embodiment of the present disclosure, the multiple groups of laminations have regularly-polygonal inner bores with the same number of sides; a first lamination of the multiple groups of laminations has a first vertex, and a first virtual line extends between the first vertex and an axis of the motor rotor; a second lamination of the multiple groups of laminations that is adjacent to the first lamination in the axial direction of the motor rotor has a second vertex that is adjacent to the first vertex in a circumferential direction of the motor rotor, and a second virtual line extends between the second vertex and the axis of the motor rotor; and, an angle θ formed between projections of the first virtual line and the second virtual line within a plane perpendicular to the axial direction of the motor rotor is less than or equal to 360/(n*a), where n is the number of the groups of laminations, and a is the number of the sides of the regularly-polygonal inner bore.

According to an embodiment of the present disclosure, p is the number of pole pairs of the rotor, LCM((2*p, a) is the least common multiple between the number of the sides of the regularly-polygonal inner bore and the number of poles of the rotor; if LCM(2*p, a)=a, the angle θ is less than 360/[2*LCM(2*p, a)], and if LCM(2*p, a)≠a, the angle θ is less than 360/LCM(2*p, a).

According to an embodiment of the present disclosure, Q is the number of slots of the rotor, LCM(Q, a) is the least common multiple between the number of the sides of the regularly-polygonal inner bore and the number of the slots; if LCM(Q, a)=a, the angle θ is less than 360/[2*LCM(Q, a)], and if LCM(Q, a)≠a, the angle θ is less than 360/LCM(Q, a).

According to an embodiment of the present disclosure, the motor rotor is a rotor of a permanent magnet motor or a rotor of an induction motor.

According to an embodiment of the present disclosure, the regularly-polygonal inner bore of one group of laminations of the multiple groups of laminations is greater than the regularly-polygonal inner bore of another group of laminations of the multiple groups of laminations, and each side of the regularly-polygonal inner bore of the one group of laminations has two intersections with the sides of the regularly-polygonal inner bore of the another group of laminations.

According to an embodiment of the present disclosure, the motor rotor further includes: a shaft fitting into the regularly-polygonal inner bores of the multiple groups of laminations, and having a radius r2 which satisfies:

r1+0.015≤r2≤r1+sin(90−360/2/a)*r/sin(90+θ/2)−r*cos(360/2/a),

where, r1 is a radius of an inscribed circle of the regularly-polygonal inner bore, r is a distance from a vertex of the regularly-polygonal inner bore to the axis of the motor rotor.

According to an embodiment of the present disclosure, 0.04≤sin(90−360/2/a)*r/sin(90+θ/2)−r*cos(360/2/a).

According to an embodiment of the present disclosure, one or more positioning holes or positioning notches are provided in the multiple groups of laminations, and the one or more positioning holes or positioning notches are parallel to an axis of the motor rotor and form a through hole or slot.

According to an embodiment of the present disclosure, multiple positioning holes or positioning notches are provided in the multiple groups of laminations, the multiple positioning holes or positioning notches are parallel to an axis of the motor rotor and form a through hole or notch, and the multiple positioning holes or positioning notches are distributed in a non-rotationally symmetric manner.

According to an embodiment of the present disclosure, the one or more positioning holes are positioned on a rotor yoke, the rotor yoke is a core portion between a permanent magnet slot and a rotor inner bore constituted by the inner bores of the multiple groups of laminations, or is a core portion between a slot of the rotor and the rotor inner bore.

According to an embodiment of the present disclosure, projections of the multiple positioning holes or positioning notches in a plane perpendicular to an axial direction of the rotor do not coincide with each other.

According to an embodiment of the present disclosure, the one or more positioning notches are formed on one or more of the sides of the regularly-polygonal inner bore in each lamination of the multiple groups of laminations.

According to an embodiment of the present disclosure, the one or more positioning notches are positioned on an outer circumference of the motor rotor.

According to an embodiment of the present disclosure, the multiple groups of laminations comprise two groups of laminations.

According to an embodiment of the present disclosure, the number of the sides of the regularly-polygonal inner bore of the multiple groups of laminations is an even number.

According to an embodiment of the present disclosure, the multiple groups of laminations comprise a first lamination and a second lamination, the inner bore of the first lamination has an inner circumference having a substantially trapezoidal-shaped wave, the inner bore of the second lamination has an inner circumference having a substantially trapezoidal-shaped wave, the trapezoidal-shaped wave having a wave valley close to an axis of the motor rotor and a wave crest close to an outer circumference of the motor rotor; at least a portion of the wave crest of the trapezoidal-shaped wave of one of the inner bore of the first lamination and the inner bore of the second lamination coincides in position with the wave valley of the trapezoidal-shaped wave of the other of the inner bore of the first lamination and the inner bore of the second lamination in a circumferential direction.

According to an embodiment of the present disclosure, the inner circumference of the inner bore of the first lamination and the inner circumference of the inner bore of the second lamination have substantially the same trapezoidal-shaped wave.

According to an embodiment of the present disclosure, a width of the wave valley of the trapezoidal-shaped wave is less than or equal to a width of the wave crest.

According to an embodiment of the present disclosure, two endpoints of each wave valley of the trapezoidal-shaped wave are positioned on a first circle having a radius of R1, and two endpoints of each wave crest of the trapezoidal-shaped wave are positioned on a second circle having a radius of R2.

According to an embodiment of the present disclosure, a center of the first circle and a center of the second circle coincide with the axis of the motor rotor.

According to an embodiment of the present disclosure, a ratio of the width of the wave valley of the trapezoidal-shaped wave to the width of the wave crest is greater than a ratio R1/R2 of the radius R1 of the first circle to the radius R2 of the second circle, or is less than the ratio R1/R2; and the width of the wave valley is less than or equal to π*R1/n, where n is the number of the wave crests and the wave valleys of the trapezoidal-shaped wave of the inner circumference of each of the inner bore of the first lamination and the inner bore of the second lamination.

According to an embodiment of the present disclosure, the trapezoidal-shaped wave includes a transition part extending between the wave valley and the wave crest, and the transition part includes a straight-line segment.

According to an embodiment of the present disclosure, the motor rotor further includes: a shaft having a radius of R3, wherein, R1≤R3<R2.

According to an embodiment of the present disclosure, a virtual line extending from a midpoint of the wave crest of the trapezoidal-shaped wave of one of the inner bore of the first lamination and the inner bore of the second lamination to a corresponding midpoint of the wave valley of the trapezoidal-shaped wave of the other of the inner bore of the first lamination and the inner bore of the second lamination goes through the axis of the motor rotor.

According to an embodiment of the present disclosure, the radius R1 of the first circle of the inner bore of the first lamination is equal to the radius R1 of the first circle of the inner bore of the second lamination, the radius R2 of the second circle of the inner bore of the first lamination is equal to the radius R2 of the second circle of the inner bore of the second lamination, the width of the wave valley of the trapezoidal-shaped wave of the inner bore of the first lamination is equal to the width of the wave valley of the trapezoidal-shaped wave of the inner bore of the second lamination, and the width of the wave crest of the trapezoidal-shaped wave of the inner bore of the first lamination is equal to the width of the wave crest of the trapezoidal-shaped wave of the inner bore of the second lamination.

According to an embodiment of the present disclosure, the wave crest of the trapezoidal-shaped wave is a first arc of which a center is at the axis of the motor rotor and which has a radius of R5, and the wave valley of the trapezoidal-shaped wave is a second arc of which a center is at the axis of the motor rotor and which has a radius of R6.

According to an embodiment of the present disclosure, a transition part between the wave valley of the trapezoidal-shaped wave and the wave crest of the trapezoidal-shaped wave includes a first connecting arc and a second connecting arc having radiuses of R7 and R8, respectively, the first arc is tangent to the second connecting arc, the second arc is tangent to the first connecting arc, and the first connecting arc is tangent to the second connecting arc.

According to an embodiment of the present disclosure, a central angle a corresponding to the wave crest of the trapezoidal-shaped wave is greater than or equal to a central angle β corresponding to the wave valley of the trapezoidal-shaped wave, and

cos(δ)=[(R6+R8)2+(R5−R7)2−(R7+R8)2]/[2*(R6+R8)*(R5−R7)],

where, δ is an angle between a virtual line extending from a center of the first connecting arc to the axis of the motor rotor and a virtual line extending from a center of the second connecting arc to the axis of the motor rotor.

According to an embodiment of the present disclosure, the central angle β corresponding to the wave valley of the trapezoidal-shaped wave is an integer that is greater than one but is less than 360/(2n)−δ, and R8=R7, where n is the number of the wave valleys of the trapezoidal-shaped wave, and n is an even number.

According to an embodiment of the present disclosure, there is provided a motor comprising: a stator; and the abovementioned motor rotor provided in the stator.

Configurations of the motor rotor and the motor according to embodiments of the present disclosure, for example, may reduce installation costs of the lamination and the rotor shaft in the motor rotor.

### BRIEF DESCRIPTION OF THE DRAWINGS

FIG. 1 is a schematic view of a first lamination of a rotor according to a first embodiment of the present disclosure.

FIG. 2 is a schematic view of a second lamination of the rotor according to the first embodiment of the present disclosure.

FIG. 3 is a schematic view of the first lamination and the second lamination of the rotor which are stacked together according to the first embodiment of the present disclosure.

FIG. 4 is a schematic view of a first lamination of a rotor according to a second embodiment of the present disclosure.

FIG. 5 is a schematic view of a second lamination of the rotor according to the second embodiment of the present disclosure.

FIG. 6 is a schematic view of the first lamination and the second lamination of the rotor which are stacked together according to the second embodiment of the present disclosure.

FIG. 7 is a schematic view of a first lamination of a rotor according to a third embodiment of the present disclosure.

FIG. 8 is a schematic view of a second lamination of the rotor according to the third embodiment of the present disclosure.

FIG. 9 is a schematic view of the first lamination and the second lamination of the rotor which are stacked together according to the third embodiment of the present disclosure.

FIG. 10 is a schematic view of a first lamination of a rotor according to a fourth embodiment of the present disclosure.

FIG. 11 is a schematic view of a second lamination of the rotor according to the fourth embodiment of the present disclosure.

FIG. 12 is a schematic view of the first lamination and the second lamination of the rotor which are stacked together according to the fourth embodiment of the present disclosure.

FIG. 13 is a schematic view of a first lamination of a rotor according to a fifth embodiment of the present disclosure.

FIG. 14 is a schematic view of a second lamination of the rotor according to the fifth embodiment of the present disclosure.

FIG. 15 is a schematic view of the first lamination and the second lamination of the rotor which are stacked together according to the fifth embodiment of the present disclosure.

FIG. 16 is a schematic view of a first lamination of a rotor according to a sixth embodiment of the present disclosure.

FIG. 17 is a schematic view of a second lamination of the rotor according to the sixth embodiment of the present disclosure.

FIG. 18 is a schematic view of the first lamination and the second lamination of the rotor which are stacked together according to the sixth embodiment of the present disclosure.

FIG. 19 is a schematic view of an inner bore formed by the first lamination and the second lamination of the rotor which are stacked together according to the sixth embodiment of the present disclosure.

FIG. 20 is a schematic view of a perimeter around an inner bore formed by a first lamination and a second lamination of a rotor which are stacked together according to a seventh embodiment of the present disclosure.

FIG. 21 is a schematic view of a perimeter of an inner bore of a first lamination of a rotor according to an eighth embodiment of the present disclosure.

FIG. 22 is a schematic view of a perimeter of an inner bore of a second lamination of the rotor according to the eighth embodiment of the present disclosure.

FIG. 23 is a schematic view of a perimeter of an inner bore formed by the first lamination and the second lamination of the rotor which are stacked together according to the eighth embodiment of the present disclosure.

FIG. 24 is a schematic view of a perimeter of an inner bore of a first lamination of a rotor according to a ninth embodiment of the present disclosure.

FIG. 25 is a schematic view of a perimeter of an inner bore of a second lamination of the rotor according to the ninth embodiment of the present disclosure.

FIG. 26 is a schematic view of a perimeter of an inner bore formed by the first lamination and the second lamination of the rotor which are stacked together according to the ninth embodiment of the present disclosure.

FIG. 27 is a schematic view of a geometric relationship among a perimeter of an inner bore formed by the first lamination and the second lamination of the rotor which are stacked together according to the seventh embodiment of the present disclosure, a perimeter of an inner bore formed by the first lamination and the second lamination of the rotor which are stacked together according to the eighth embodiment of the present disclosure, and a perimeter of an inner bore formed by the first lamination and the second lamination of the rotor which are stacked together according to the ninth embodiment of the present disclosure.

FIG. 28 is a schematic view of a perimeter of an inner bore of a first lamination of a rotor according to a tenth embodiment of the present disclosure, in which a groove is configured at a wave crest of a trapezoidal-shaped wave.

FIG. 29 is a schematic view of a perimeter of an inner bore of a second lamination of the rotor according to the tenth embodiment of the present disclosure, in which a through hole is formed outside a wave valley of a trapezoidal-shaped wave.

FIG. 30 is a schematic view of a perimeter of an inner bore formed by the first lamination and the second lamination of the rotor which are stacked together according to the tenth embodiment of the present disclosure, in which a protrusion and the through hole are shown.

### DETAILED DESCRIPTION

The embodiments of the present disclosure will be described hereinafter with reference to the accompanying drawings.

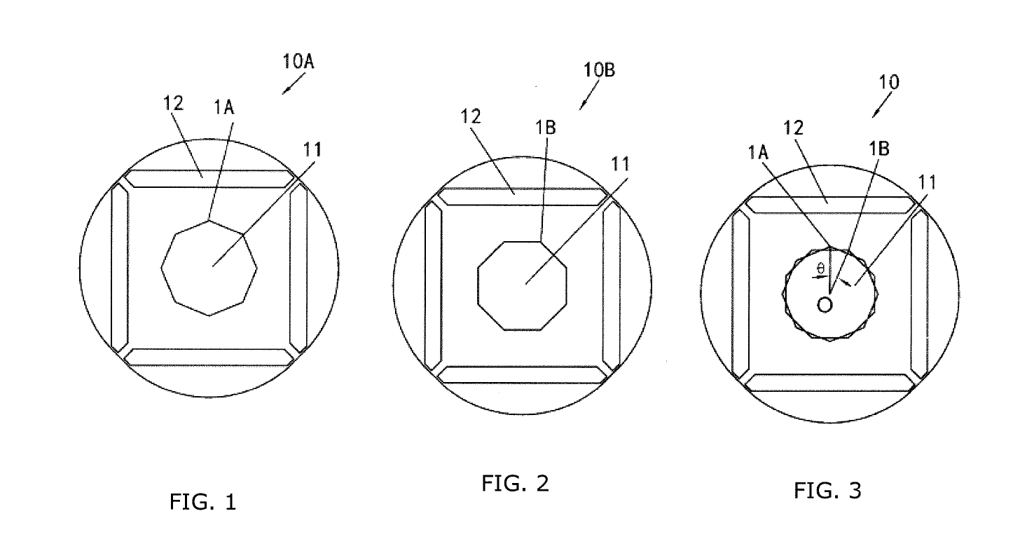

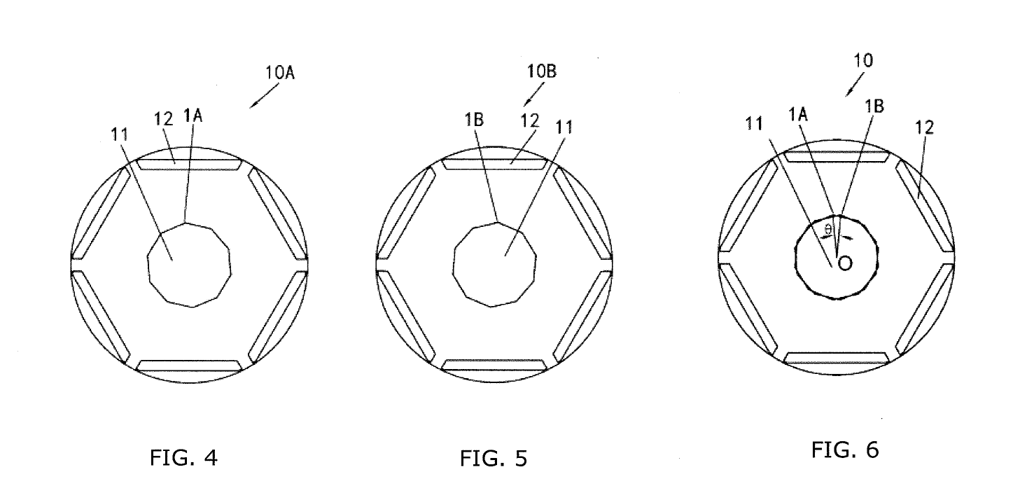

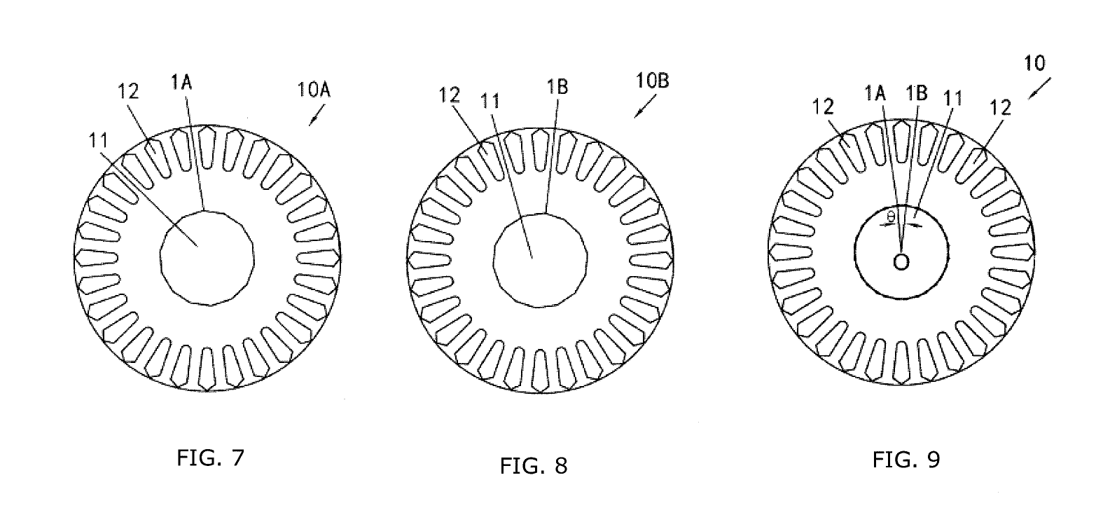

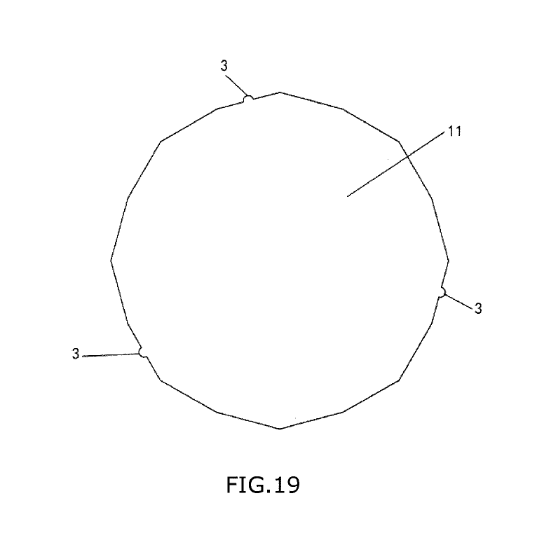

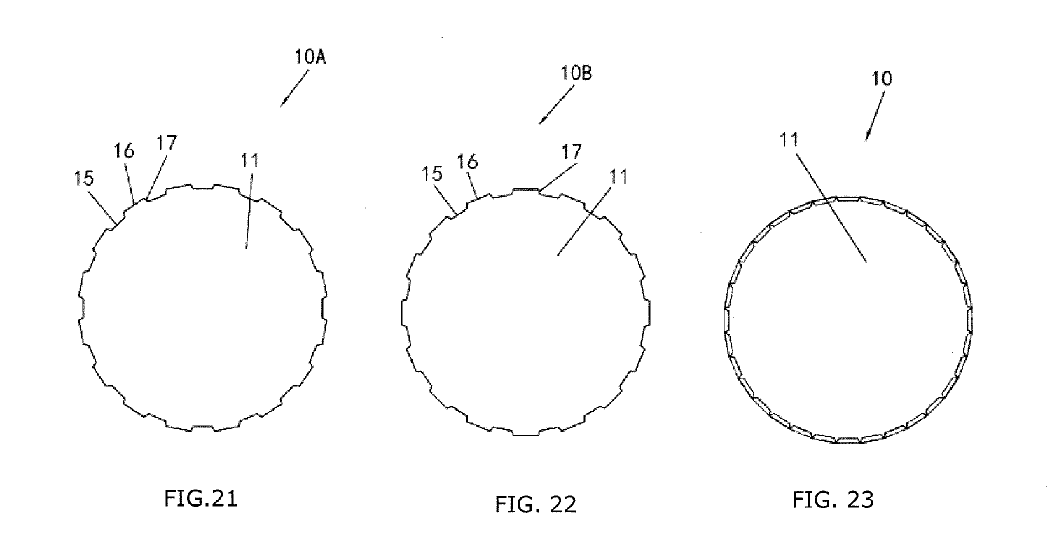

Referring to FIGS. 1-30, a motor according to an embodiment of the present disclosure includes a stator and a motor rotor in the stator. The motor rotor may be a rotor of a permanent magnet motor or a rotor of an induction motor. As to the permanent magnet motor, a rotor of an interior permanent magnet motor includes: a permanent magnet; and a rotor core including a first rotor lamination 10A and a second rotor lamination 10B and a permanent magnet slot which is an example of a rotor slot. Each of the first rotor lamination 10A and the second rotor lamination 10B has an opening 12 which forms the permanent magnet slot, and the permanent magnet is accommodated in the permanent magnet slot. As to the induction motor, a rotor of an induction motor includes: a rotor core including a first rotor lamination 10A and a second rotor lamination 10B and a coil slot which is an example of a rotor slot. Each of the first rotor lamination 10A and the second rotor lamination 10B has an opening 12 which forms the coil slot, and at least a portion of a coil is accommodated in the coil slot.

Referring to FIGS. 1-30, a motor rotor according to an embodiment of the present disclosure includes multiple groups of laminations 10, and the multiple groups of laminations 10 have inner bores 11 and are arranged alternately in an axial direction of the motor rotor.

Referring to FIGS. 1-19, according to an embodiment of the present disclosure, the multiple groups of laminations 10 have regularly-polygonal inner bores 11 with the same number of sides. A first lamination 10A of the multiple groups of laminations 10 has a first vertex 1A, a first virtual line may be described between the first vertex 1A and an axis O of the motor rotor. A second lamination 10B that is adjacent to the first lamination 10A in the axial direction of the motor rotor has a second vertex 1B that is adjacent to the first vertex 1A in a circumferential direction of the motor rotor, a second virtual line may be described between the second vertex 1B and the axis O of the motor rotor. An angle θ between the first virtual line and the second virtual line on a projection plane of the motor rotor perpendicular to the axial direction of the motor rotor is less than or equal to 360/(n*a), where n is the number of the groups of laminations 10, and a is the number of the sides of the regularly-polygonal inner bore 11. The multiple groups of laminations 10 may include two, three or more groups of laminations 10. The number of the sides of the regularly-polygonal inner bore 11 of the multiple groups of laminations 10 may be an even number.

In an example of the present disclosure, p is the number of pole pairs of the rotor, LCM (2*p, a) is the least common multiple between the number of the sides of the regularly-polygonal inner bore and the number of poles of the rotor; when LCM (2*p, a)=a, the angle θ is less than 360/[2*LCM(2*p, a)], and when LCM(2*p, a)≠a, the angle θ is less than 360/LCM(2*p, a). In another example of the present disclosure, Q is the number of slots of the rotor, LCM(Q, a) is the least common multiple between the number of the sides of the regularly-polygonal inner bore and the number of the slots of the rotor; when LCM (Q, a)=a, the angle θ is less than 360/[2*LCM(Q, a)], and when LCM(Q, a)≠a, the angle θ is less than 360/LCM(Q, a).

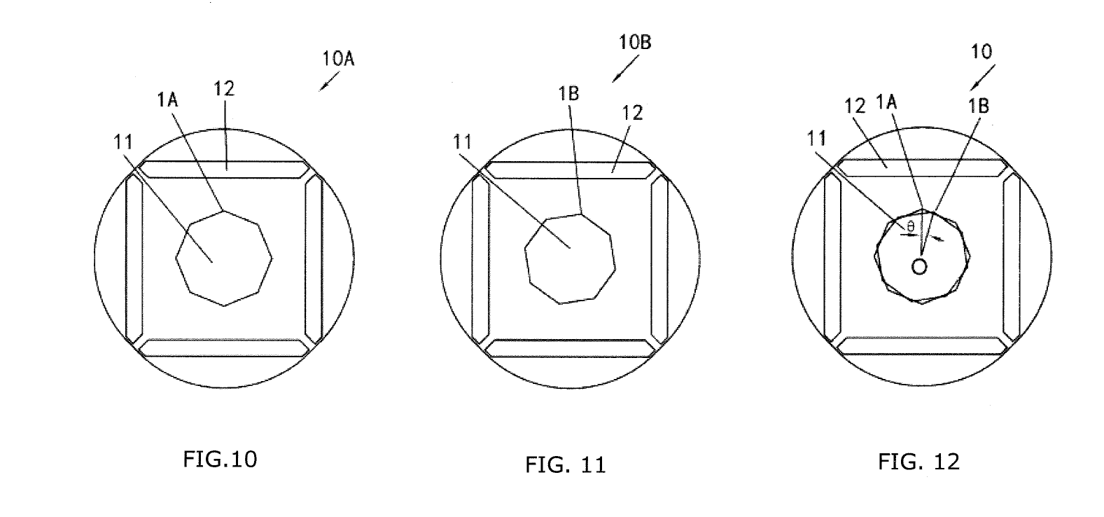

Referring to FIGS. 10-12, according to an embodiment of the present disclosure, the regularly-polygonal inner bore 11 of one group of laminations 10A of the multiple groups of laminations 10 is larger than the regularly-polygonal inner bore 11 of another group of laminations 10B of the multiple groups of laminations 10, and each side of the regularly-polygonal inner bore 11 of one group of laminations 10 has two intersections with a side of the regularly-polygonal inner bore 11 of another group of laminations 10. For example, a circumscribed circle of the regularly-polygonal inner bore 11 of one group of laminations 10A among the multiple groups of laminations 10 has a radius larger than a radius of a circumscribed circle of the regularly-polygonal inner bore 11 of another group of laminations 10B among the multiple groups of laminations 10.

Referring to FIGS. 1-19, the motor rotor further includes a shaft fit into the regularly-polygonal inner bores 11 of the multiple groups of laminations 10 according to an embodiment of the present disclosure. The shaft may be mounted into the regularly-polygonal inner bore 11 of the laminations 10 by cold pressing installation or hot pressing installation. The shaft has a radius r2 which satisfies:

r1+0.015≤r2≤r1+sin(90−360/2/a)*r/sin(90+θ/2)−r*cos(360/2/a),

where, r1 is a radius of an inscribed circle of the regularly-polygonal inner bore 11, r is a distance from a vertex of the regularly-polygonal inner bore 11 to the axis O of the motor rotor. In an example of the present disclosure, 0.04≤sin(90−360/2/a)*r/sin(90+θ/2)−r*cos(360/2/a).

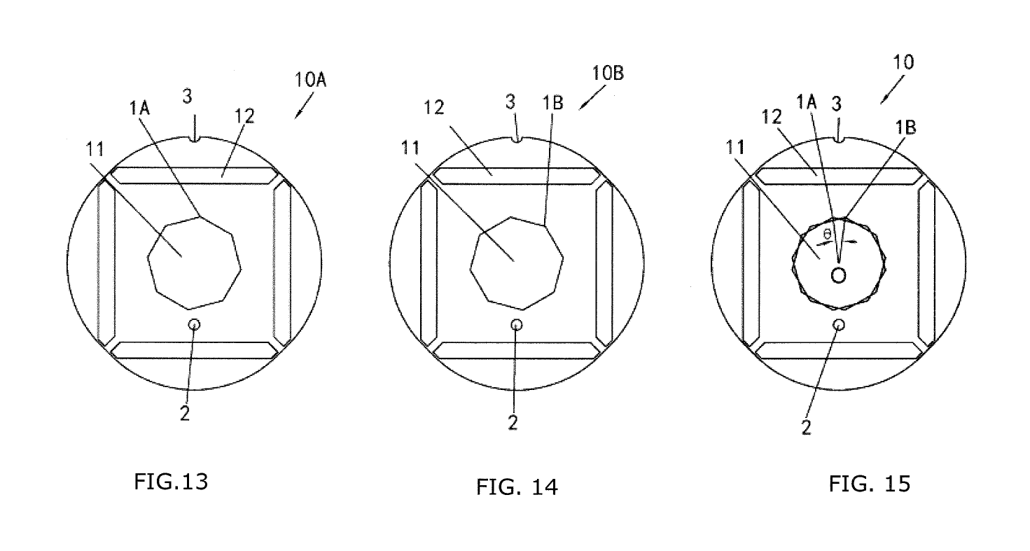

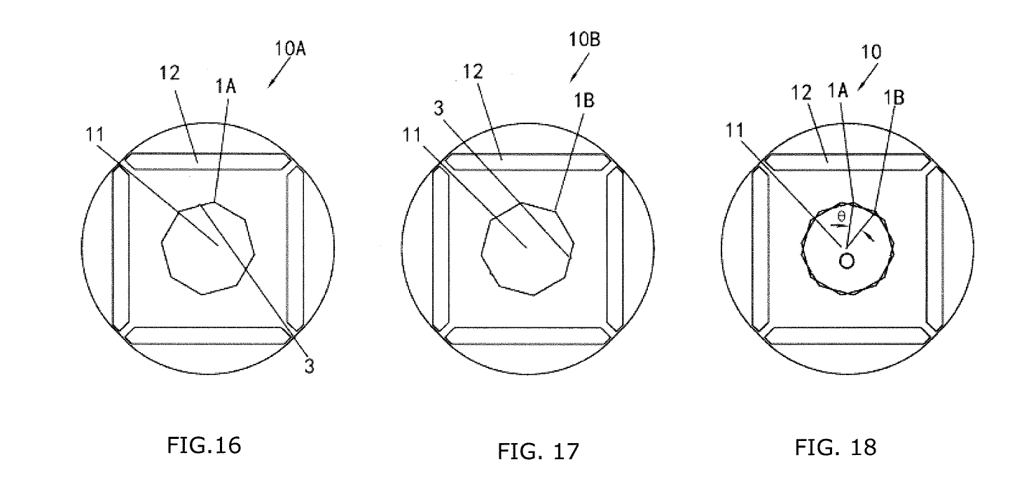

Referring to FIGS. 13-19 and FIGS. 28-30, one or more positioning holes 2 or positioning notches 3 are provided in the multiple groups of laminations 10 according to an embodiment of the present disclosure, the one or more positioning holes 2 or positioning notches 3 are parallel to an axis of the motor rotor and form through hole(s) or through notch(es). In an example of the present disclosure, multiple positioning holes 2 or positioning notches 3 are provided in the multiple groups of laminations 10, and the multiple positioning holes 2 or positioning notches 3 are distributed asymmetrically along a circumference. One or more positioning holes 2 may be positioned on a rotor yoke, which is a core portion between a permanent magnet slot and a rotor inner bore formed by the inner bores 11 of the multiple groups of laminations 10, or which is a core portion between a rotor slot and the rotor inner bore 11. Projections of the multiple positioning holes or positioning notches in a plane perpendicular to an axial direction of the rotor may not coincide with each other. As shown in FIGS. 16-19, one or more positioning notches 3 are formed on one or more of the sides of the regularly-polygonal inner bore 11 in each lamination of the multiple groups of laminations 10, for example, at center positions of the one or more of the sides, for positioning the rotor lamination 10 as well as reducing pressing force during press installation of the shaft. As shown in FIGS. 13-15, one or more positioning notches are positioned on an outer circumference of the motor rotor.

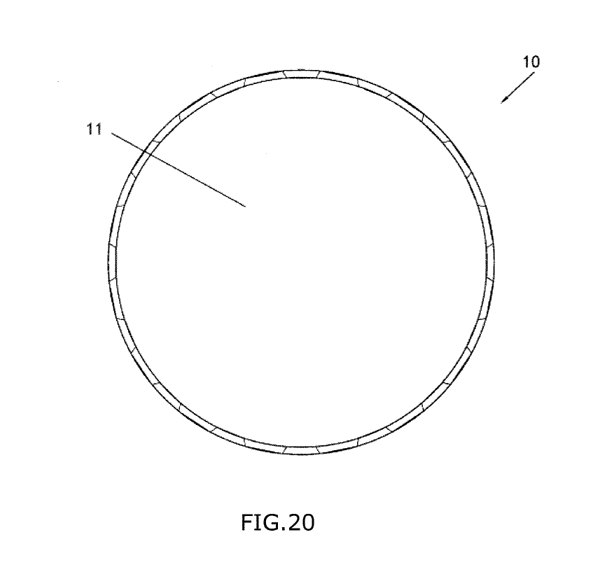

Referring to FIGS. 20-30, the multiple groups of laminations 10 include a first lamination 10A and a second lamination 10B according to an embodiment of the present disclosure, the inner bore 11 of the first lamination 10A has an inner circumference having a substantially trapezoidal-shaped wave , the inner bore 11 of the second lamination 10B has an inner circumference having substantially trapezoidal-shaped wave, the trapezoidal-shaped wave has a wave valley 15 close to the axis of the motor rotor and a wave crest 16 close to an outer circumference of the motor rotor. At least a portion of the wave crest 16 of the trapezoidal-shaped wave in one of the inner bore 11 of the first lamination 10A and the inner bore 11 of the second lamination 10B coincides in position with the wave valley 15 of the trapezoidal-shaped wave of the other inner bore 11 in a circumferential direction. For example, a virtual line extending from a midpoint of the wave crest 16 of the trapezoidal-shaped wave in one of the inner bore 11 of the first lamination 10A and the inner bore 11 of the second lamination 10B to a corresponding midpoint of the wave valley 15 of the trapezoidal-shaped wave of the other inner bore 11 goes through the axis of the motor rotor. The inner circumference of the inner bore 11 of the first lamination 10A may have a substantially same trapezoidal-shaped wave as the inner circumference of the inner bore 11 of the second lamination 10B. A width of the wave valley 15 of the trapezoidal-shaped wave may be less than or equal to a width of the wave crest 16. The width of the wave valley is a straight-line distance between two endpoints of the wave valley, and the width of the wave crest is a straight-line distance between two endpoints of the wave crest. In an example of the present disclosure, the wave valleys 15 of the inner circumference of the inner bore 11 of the first lamination 10A do not coincide with the wave valleys 15 of the inner circumference of the inner bore 11 of the second lamination 10B, which can reduce pressing force.

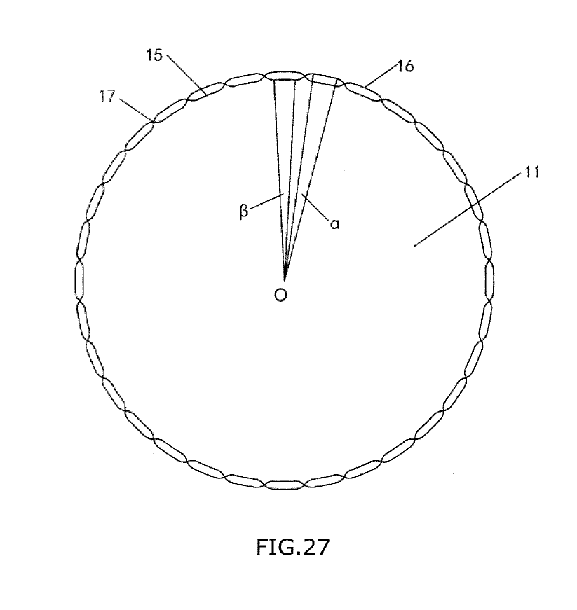

Referring to FIG. 27, two endpoints of each wave valley 15 of the trapezoidal-shaped wave are positioned on a first circle having a radius of R1 according to an embodiment of the present disclosure, and two endpoints of each wave crest 16 of the trapezoidal-shaped wave are positioned on a second circle having a radius of R2. A center of the first circle and a center of the second circle may coincide with the axis O of the motor rotor. In an example of the present disclosure, a ratio of the width of the wave valley 15 of the trapezoidal-shaped wave to the width of the wave crest 16 is greater than a ratio R1/R2, or is less than the ratio R1/R2. The width of the wave valley 15 may be less than or equal to π*R1/n, where n is the number of the wave crests 16 or wave valleys 15 of the trapezoidal-shaped wave at the inner circumference of each of the inner bore 11 of the first lamination 10A and the inner bore 11 of the second lamination 10B if the number of the wave crests 16 and the number of the wave valleys 15 are equal to each other. If the number of the wave crests 16 and the number of the wave valleys 15 are not equal to each other, n is the larger one among the number of the wave crests 16 and the number of the wave valleys 15. According to an embodiment of the present disclosure, the motor rotor further includes: a shaft having a radius of R3, wherein, R1≤R3<R2. The shaft can be mounted into the regularly-polygonal inner bores 11 of the laminations 10 by cold pressing installation or hot pressing installation.

Referring to FIGS. 20-30, the trapezoidal-shaped wave may include a transition part 17 extending between the wave crest 16 and the wave valley 15, and the transition part may include a straight-line segment (as shown in FIGS. 20-23 and FIGS. 28-30) according to an embodiment of the present disclosure. There may be an arc segment or a chamfer between the transition part 17 and the wave crest 16 as well as between the transition part 17 and the wave valley 15. Alternatively, the transition part may include a straight-line segment, or a curve segment or both.

Referring to FIGS. 20-30, according to an embodiment of the present disclosure, the radius R1 of the first circle of the inner bore 11 of the first lamination 10A is equal to the radius R1 of the first circle of the inner bore 11 of the second lamination 10B, the radius R2 of the second circle of the inner bore 11 of the first lamination 10A is equal to the radius R2 of the second circle of the inner bore 11 of the second lamination 10B, the width of the wave valley 15 of the trapezoidal-shaped wave of the inner bore 11 of the first lamination 10A is equal to the width of the wave valley 15 of the trapezoidal-shaped wave of the inner bore 11 of the second lamination 10B, and the width of the wave crest 16 of the trapezoidal-shaped wave of the inner bore 11 of the first lamination 10A is equal to the width of the wave crest 16 of the trapezoidal-shaped wave of the inner bore 11 of the second lamination 10B.

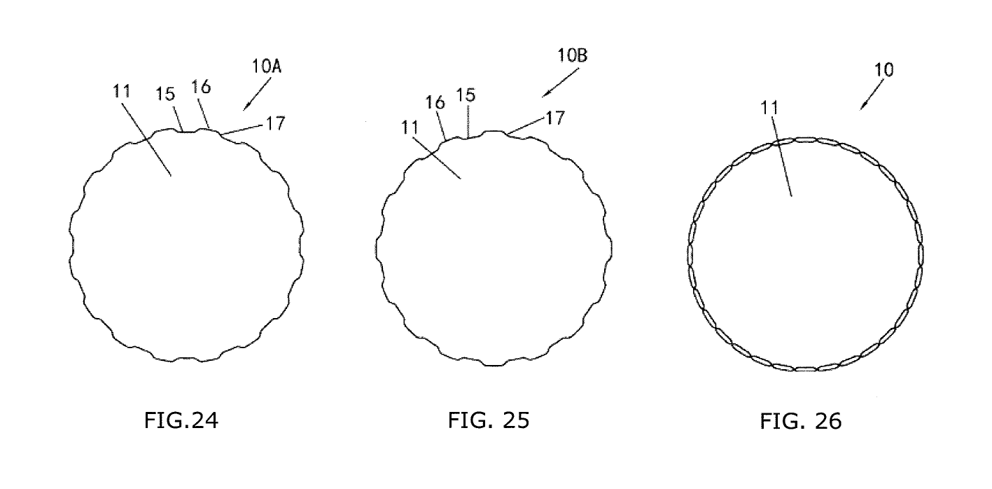

Referring to FIGS. 20-30, according to an embodiment of the present disclosure, the wave crest 16 of the trapezoidal-shaped wave is at a first arc which has a center at the axis O of the motor rotor and which has a radius of R5, the wave valley 15 of the trapezoidal-shaped wave is at a second arc which has a center at the axis O of the motor rotor and which has a radius of R6. In an example of the present disclosure, referring to FIGS. 24-27, the transition part between the wave valley 15 of the trapezoidal-shaped wave and the wave crest 16 of the trapezoidal-shaped wave may include a first connecting arc with a radius R7 and a second connecting arc with a radius R8, the first arc is tangent to the second connecting arc, the second arc is tangent to the first connecting arc, and the first connecting arc is tangent to the second connecting arc. This arrangement causes no sharp portion of stress concentration at the lamination. Before the shaft is pressed into the inner bore of the laminations, the arc-shaped valley 15 with the same center of the rotor may enable better positioning of the shaft, thereby reducing a possibility that the shaft is deviated from the axis O of the rotor when the shaft is pressed into the inner bore of the laminations. In an example of the present disclosure, a central angle a corresponding to the wave crest 16 of the trapezoidal-shaped wave may be greater than or equal to a central angle β corresponding to the wave valley 15 of the trapezoidal-shaped wave, and cos(δ)=[(R6+R8)2+(R5−R7)2−(R7+R8)2]/[2*(R6+R8)*(R5−R7)], where, δ is an angle between a virtual line extending from a center of the first connecting arc to the axis O of the motor rotor and a virtual line extending from a center of the second connecting arc to the axis O of the motor rotor. In an example of the present disclosure, the central angle β corresponding to the wave valley 15 of the trapezoidal-shaped wave is an integer that is greater than one but is less than 360/(2n)−δ, and R8=R7, where n is the number of the wave valleys 15 of the trapezoidal-shaped wave, and n is an even number.

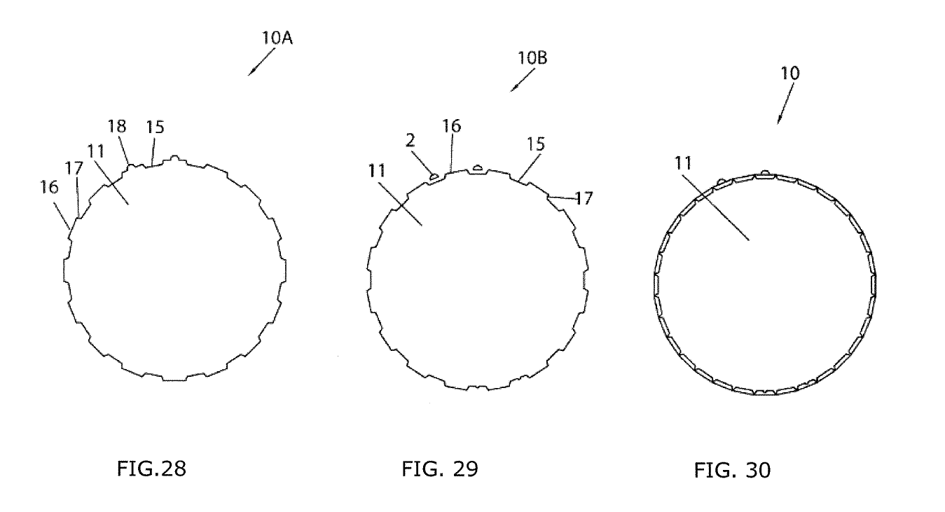

Referring to FIGS. 28-30, according to an embodiment of the present disclosure, the wave crest 16 of the trapezoidal-shaped wave is configured with a groove 18, and a through hole 2 is configured at a side of the wave valley 15 of the trapezoidal-shaped wave close to the outer circumference of the lamination. The groove 18 may be used to relieve stress partially, and the through hole 2 may be used for positioning the lamination.

In addition, new embodiments can be achieved by combining the abovementioned embodiments of the present disclosure.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A motor rotor, comprising:
multiple groups of laminations, the multiple groups of laminations having inner bores and arranged alternately in an axial direction of the motor rotor;
wherein:
the multiple groups of laminations comprise regularly-polygonal inner bores with the same number of sides;
a first lamination of the multiple groups of laminations has a first vertex, and a first virtual line extends between the first vertex and an axis of the motor rotor; a second lamination of the multiple groups of laminations that is adjacent to the first lamination in the axial direction of the motor rotor has a second vertex that is adjacent to the first vertex in a circumferential direction of the motor rotor, and a second virtual line extends between the second vertex and the axis of the motor rotor; and, an angle θ formed between projections of the first virtual line and the second virtual line within a plane perpendicular to the axial direction of the motor rotor is less than or equal to 360/(n*a), wherein n is the number of the groups of laminations, and a is the number of the sides.

2. (canceled)

3. The motor rotor of claim 1, wherein:
the angle θ is less than 360/[2*LCM(2*p, a)] if LCM(2*p, a)=a, and the angle θ is less than 360/LCM(2*p, a) if LCM(2*p, a)≠a, wherein p is the number of pole pairs of the motor rotor, LCM (2*p, a) is the least common multiple between the number of the sides and the number of poles of the motor rotor; or
wherein:
the angle θ is less than 360/[2*LCM(Q, a)] if LCM(Q, a)=a, and the angle θ is less than 360/LCM(Q, a) if LCM(Q, a)≠a; wherein Q is the number of slots of the rotor, LCM(Q, a) is the least common multiple between the number of the sides and the number of the slots.

4. (canceled)

5. (canceled)

6. The motor rotor of claim 1, wherein:
one group of laminations among the multiple groups of laminations has a regularly-polygonal inner bore larger than a regularly-polygonal inner bore of another group of laminations among the multiple groups of laminations, and each side of the regularly-polygonal inner bore of said one group of laminations has two intersections with sides of the regularly-polygonal inner bore of said another group of laminations.

7. The motor rotor of claim 1, further comprising:
a shaft, fit into the regularly-polygonal inner bores of the multiple groups of laminations and having a radius r2 which satisfies:
r1+0.015≤r2≤r1+sin(90−360/2/a)*r/sin(90+θ/2)−r*cos(360/2/a),
where, r1 is a radius of an inscribed circle of a regularly-polygonal inner bore, and r is a distance from a vertex of the regularly-polygonal inner bore to the axis of the motor rotor.

8. The motor rotor of claim 7, wherein:
0.04≤sin(90−360/2/a)*r/sin(90+θ/2)−r*cos(360/2/a).

9. The motor rotor of claim 1, wherein:
one or more positioning holes or positioning notches are provided in the multiple groups of laminations, and the one or more positioning holes or positioning notches are parallel to an axis of the motor rotor and form a through hole or slot; or
wherein:
multiple positioning holes or positioning notches are provided in the multiple groups of laminations,
the multiple positioning holes or positioning notches are parallel to an axis of the motor rotor and form a through hole or notch, and
the multiple positioning holes or positioning notches are distributed in a non-rotationally symmetric manner.

10. (canceled)

11. The motor rotor of claim 9, wherein:
the one or more positioning holes are positioned on a rotor yoke;
wherein the rotor yoke is a core portion between a permanent magnet slot and a rotor inner bore constituted by the inner bores of the multiple groups of laminations, or is a core portion between a slot of the rotor and the rotor inner bore.

12. (canceled)

13. The motor rotor of claim 9, wherein:
the one or more positioning notches are formed on one or more of sides of a regularly-polygonal inner bore in each lamination of the multiple groups of laminations; or
wherein:
the one or more positioning notches are positioned on an outer circumference of the motor rotor.

14. (canceled)

15. (canceled)

16. (canceled)

17. A motor rotor, comprising:
multiple groups of laminations, the multiple groups of laminations having inner bores and arranged alternately in an axial direction of the motor rotor; wherein:
the multiple groups of laminations comprise a first lamination and a second lamination, the inner bore of the first lamination has an inner circumference in a substantially trapezoidal wave shape, the inner bore of the second lamination has an inner circumference in a substantially trapezoidal wave shape, the trapezoidal wave shape having a wave valley close to an axis of the motor rotor and a wave crest close to an outer circumference of the motor rotor;
at least a portion of the wave crest of the trapezoidal wave shape in one of the inner bore of the first lamination and the inner bore of the second lamination coincides in position in a circumferential direction with the wave valley of the trapezoidal wave shape of the other of the inner bore of the first lamination and the inner bore of the second lamination.

18. The motor rotor of claim 17, wherein:
the inner circumference of the inner bore of the first lamination is in a trapezoidal wave shape substantially the same as the inner circumference of the inner bore of the second lamination.

19. (canceled)

20. The motor rotor of claim 17, wherein:
two endpoints of each wave valley of the trapezoidal wave shape are positioned on a first circle with a radius R1, and two endpoints of each wave crest of the trapezoidal wave shape are positioned on a second circle with a radius R2.

21. The motor rotor of claim 20, wherein:
a center of the first circle and a center of the second circle coincide with the axis of the motor rotor.

22. The motor rotor of claim 21, wherein:
a ratio of the width of the wave valley of the trapezoidal wave shape to the width of the wave crest is greater than a ratio R1/R2 of the radius R1 of the first circle to the radius R2 of the second circle, or is less than the ratio R1/R2; and
the width of the wave valley is less than or equal to π*R1/n, where n is the number of the wave crests or wave valleys of the trapezoidal wave shape of the inner circumference for any of the inner bore of the first lamination and the inner bore of the second lamination.

23. (canceled)

24. (canceled)

25. The motor rotor of claim 17, wherein:
a virtual line extending from a midpoint of the wave crest of the trapezoidal wave shape for one of the inner bore of the first lamination and the inner bore of the second lamination to a corresponding midpoint of the wave valley of the trapezoidal wave shape for the other inner bore goes through the axis of the motor rotor.

26. The motor rotor of claim 21, wherein:
the radius R1 of the first circle of the inner bore of the first lamination is equal to the radius R1 of the first circle of the inner bore of the second lamination, the radius R2 of the second circle of the inner bore of the first lamination is equal to the radius R2 of the second circle of the inner bore of the second lamination, the width of the wave valley of the trapezoidal wave shape of the inner bore of the first lamination is equal to the width of the wave valley of the trapezoidal wave shape of the inner bore of the second lamination, and the width of the wave crest of the trapezoidal wave shape of the inner bore of the first lamination is equal to the width of the wave crest of the trapezoidal wave shape of the inner bore of the second lamination.

27. The motor rotor of claim 17, wherein:
the wave crest of the trapezoidal wave shape is a first arc which has a center at the axis of the motor rotor and which has a radius R5, and the wave valley of the trapezoidal wave shape is a second arc which has a center at the axis of the motor rotor and which has a radius R6.

28. The motor rotor of claim 17, wherein:
a transition part between the wave valley of the trapezoidal wave shape and the wave crest of the trapezoidal wave shape comprises a first connecting arc with a radius R7 and a second connecting arc with a radius R8, the first arc is tangent to the second connecting arc, the second arc is tangent to the first connecting arc, and the first connecting arc is tangent to the second connecting arc.

29. The motor rotor of claim 28, wherein:
a central angle α corresponding to the wave crest of the trapezoidal wave shape is greater than or equal to a central angle β corresponding to the wave valley of the trapezoidal wave shape, and
cos(δ)=[(R6+R8)2+(R5−R7)2−(R7+R8)2]/[2*(R6+R8)*(R5−R7)],
where, δ is an angle between a virtual line extending from a center of the first connecting arc to the axis of the motor rotor and a virtual line extending from a center of the second connecting arc to the axis of the motor rotor.

30. The motor rotor of claim 29, wherein:
the central angle β corresponding to the wave valley of the trapezoidal wave shape is an integer that is greater than one but is less than 360/(2n)−δ, and R8=R7, where n is the number of the wave valleys of the trapezoidal wave shape, and n is an even number.

31. A motor, comprising:
a stator; and
the motor rotor of claim 1, provided in the stator.
